(19) United States
(12) Patent Application Publication
(10) Pub. No.: US 2026/0261230 A1
(43) Pub. Date: Sep. 3, 2026

(54) BUILDING INTEGRATED PHOTOVOLTAICS PARKING GARAGE WITH THERMAL INSULATION EFFECTS

(71) Applicant: Shun Kee LEE, HongKong (CN)

(72) Inventor: Shun Kee LEE, HongKong (CN)

(21) Appl. No.: 19/655,748

(22) Filed: Apr. 23, 2026

Related U.S. Application Data
(63) Continuation of application No. PCT/CN2025/138349, filed on Nov. 28, 2025.

(30) Foreign Application Priority Data
Dec. 25, 2024 (CN) 2024232109539

(51) Int. Cl. H02S 20/26; E04H 6/22; H02S 40/38

(52) U.S. Cl. CPC H02S 20/26; E04H 6/22; H02S 40/38

(57) ABSTRACT

A BIPV parking garage with thermal insulation effects includes a steel structure frame, a vehicle-carrying assembly, lifting assemblies, guide assemblies, and an energy storage device. The steel structure frame is divided into three levels or into multiple levels. A top of the steel structure frame is fixedly connected to a bottom of a first BIPV panel, and a second BIPV panel is fixedly mounted on a front side of the steel structure frame. The energy storage device is disposed on a left side of the steel structure frame. Each of the first BIPV panel and the second BIPV panel is electrically connected to the energy storage device via a charging cable. A discharge cable is fixedly mounted on a top of the energy storage cable. A parking and retrieval control panel is fixedly mounted on the front side of the steel structure frame.

### TECHNICAL FIELD

The disclosure relates to the field of building engineering and renewable energy technologies, and more particularly to a building integrated photovoltaics (BIPV) parking garage with thermal insulation effects.

### BACKGROUND

With the increasing global emphasis on renewable energy and the continuous improvement of building energy efficiency requirements, BIPV technology has emerged and gained widespread application. The BIPV technology organically integrates solar photovoltaic power generation systems with buildings by installing photovoltaic assemblies on roofs, walls, and other parts of the buildings, which not only generates clean energy but also replaces traditional building materials, thereby achieving dual benefits of building functionality and energy production.

Conventional outdoor parking garages commonly employ simple roof structures, which exhibit poor thermal insulation performance and are difficult to effectively block solar radiation and heat transfer. This deficiency is particularly pronounced in summer, often leading to sharp temperature increases inside vehicles. Consequently, vehicle owners are compelled to frequently use air conditioning to maintain a comfortable environment inside the vehicles, thereby greatly increasing energy consumption and operational costs. Furthermore, the widespread use of air conditioning equipment exacerbates greenhouse gas emissions, which poses a non-negligible adverse impact on the environment. In addition, roofs and interiors of the traditional outdoor parking garages contain large areas of unutilized space, resulting in notably low spatial utilization efficiency.

### SUMMARY

An objective of the disclosure is to provide a BIPV parking garage with thermal insulation effects, so as to overcome the aforementioned deficiencies in the related art.

To achieve the above objective, the disclosure adopts the following technical solution: a BIPV parking garage with thermal insulation effects, which includes a steel structure frame, a vehicle-carrying assembly, lifting assemblies, guide assemblies, and an energy storage device. The steel structure frame is divided into three levels including an upper level, a middle level, and a lower level or into multiple levels. A top of the steel structure frame is fixedly connected to a bottom of a first BIPV panel, and a second BIPV panel is fixedly mounted on a front side of the steel structure frame. The energy storage device is disposed on a left side of the steel structure frame. Each of the first BIPV panel and the second BIPV panel is electrically connected to the energy storage device via a charging cable. A discharge cable is fixedly mounted on a top of the energy storage cable. A parking and retrieval control panel is fixedly mounted on the front side of the steel structure frame.

The vehicle-carrying assembly includes lower horizontally-movable vehicle pallets, middle horizontally-movable vehicle pallets, and lifting vehicle pallets.

Each of the lifting assemblies includes a support base, a lifting motor, a first sprocket, a second sprocket, a drive shaft, and reels. A number of the reels is two, and the two reels are arranged in a left-right symmetrical configuration.

Each of the guide assemblies includes guide pulleys. The guide pulleys of each of the guide assemblies at the upper level of the steel structure frame are arranged in two groups each with two of the guide pulleys, and the two groups of the guide pulleys are arranged in a left-right symmetrical configuration. Each group of the two groups of the guide pulleys is located on a front side of a corresponding one of the two reels and shares a centerline with the reel.

Wire ropes are wound around an outside of each of the two reels, respectively pass through two of the guide pulleys that are on a same side as the reel, and extend downward. A bottom of each of the wire ropes is fixed to a top of a corresponding one of the lifting vehicle pallets via a fastener.

The BIBV parking garage with thermal insulation effects of the disclosure may achieve the following beneficial effects. By mounting BIPV panels on the top and the front side of the steel structure frame respectively, the BIPV panels serve not only as building materials providing structural support for the parking garage, but also block sunlight from the top and front side of the parking garage, thereby delivering the thermal insulation effects and reducing an internal temperature of the parking garage. In cooperation with the energy storage device, renewable energy converted by the BIPV panels can be collected and supplied for the parking garage’s own consumption, thus reducing energy costs. Furthermore, by dividing the steel structure frame into the upper, middle, and lower levels, more parking spaces can be accommodated within the steel structure frame, thereby significantly enhancing spatial utilization efficiency.

Based on the foregoing technical solution, the disclosure may be further improved as follows.

In an embodiment, the lifting motor is fixedly mounted on a top of the support base. The first sprocket is fixedly connected to an outside of a left output shaft of the lifting motor. The second sprocket is located below the first sprocket, and the first sprocket and the second sprocket are connected by a chain to form a chain drive. The drive shaft is fixedly connected to an inside of the second sprocket, and a right side of the drive shaft penetrates through and extends to a right side of the support base. Two couplings are fixedly mounted on a left side and the right side of the drive shaft, respectively. Two reel shafts are fixedly mounted on opposite sides of the two couplings, respectively. The two reels are respectively sleeved on outsides of the two reel shafts. Reel hubs are fixedly mounted on an outside of each of the two reel shafts, and are located on left and right sides of one of the two reels that is on a same side as the reel shaft. First support frames are respectively disposed on opposite sides of the two reel shafts, and second support frames are respectively disposed on facing sides of the two reels. The opposite sides of the two reel shafts are rotatably connected to facing sides of the first support frames via first bearings, respectively. Each of the two reel shafts is rotatably mounted within a corresponding one of the second support frames via a second bearing.

In an embodiment, the steel structure frame is assembled from steel structure columns and steel structure beams, and hot-rolled angle steels are fixedly mounted on the left side, a right side, and a rear side of the steel structure frame.

In an embodiment, a number of the lifting assemblies is five, and the five lifting assemblies are arranged with three at the upper level and two at the middle level within the steel structure frame. Each of the support base, first support frames, and second support frames of each of the lifting assemblies at the upper level of the steel structure frame is fixedly mounted on a top of a corresponding one of the steel structure beams at the upper level of the steel structure frame. Each of the support base, the first support frames, and the second support frames of the lifting assemblies at the middle level of the steel structure frame is fixedly connected to a top of a corresponding one of the middle horizontally-movable vehicle pallets.

In an embodiment, a number of the guide assemblies is five, and the five guide assemblies are arranged with three at the upper level and two at the middle level within the steel structure frame. Each of the guide assemblies at the middle level of the steel structure frame includes two guide pulleys arranged in a left-right symmetrical configuration.

In an embodiment, mounting seats are fixedly mounted on facing sides of adjacent two of the steel structure beams at the upper level of the steel structure frame. The mounting seats are arranged in two groups each with two of the mounting seats, and the two of the mounting seats are arranged in a front-rear symmetrical configuration. The guide pulleys of each of the guide assemblies at the upper level of the steel structure frame are fixedly mounted on tops of the mounting seats, respectively. The guide pulleys of each of the guide assemblies at the middle level of the steel structure frame are fixedly mounted on a top of a corresponding one of the middle horizontally-movable vehicle pallets.

In an embodiment, a number of the lower horizontally-movable vehicle pallets is two, and a number of the middle horizontal-movable vehicle pallets is two. The two lower horizontally-movable vehicle pallets and the two middle horizontally-movable vehicle pallets are respectively arranged on the lower level and the middle level within the steel structure frame. A number of the lifting vehicle pallets is five, and the five lifting vehicle pallets are respectively located below the five lifting assemblies.

In an embodiment, an elastic washer is fixedly mounted on a left side of the second sprocket and is located on an outside of the drive shaft.

### BRIEF DESCRIPTION OF DRAWINGS

FIG. 1 illustrates a schematic structural diagram from a front perspective of a BIPV parking garage with thermal insulation effects according to the disclosure.

FIG. 2 illustrates a schematic structural diagram from a left perspective of the BIPV parking garage with thermal insulation effects according to the disclosure.

FIG. 3 illustrates a schematic structural diagram from a top perspective of an internal structure of a steel structure frame according to the disclosure.

FIG. 4 illustrates a schematic structural diagram from a front perspective of the internal structure of the steel structure frame according to the disclosure.

FIG. 5 illustrates an enlarged cross-sectional schematic view of a lifting assembly at region A shown in FIG. 4 according to the disclosure.

FIG. 6 illustrates a schematic structural diagram of installation of hot-rolled angle steels according to the disclosure.

### Description of reference signs:

1-steel structure frame; 101-steel structure column; 102-steel structure beam; 2-vehicle-carrying assembly; 201-lower horizontally-movable vehicle pallet; 202-middle horizontal-movable vehicle pallet; 203-lifting vehicle pallet; 3-lifting assembly; 301-support base; 302-lifting motor; 303-first sprocket; 304-second sprocket; 305-drive shaft; 306-reel; 307-coupling; 308-reel shaft; 309-reel hub; 310-first support frame; 311-second support frame; 312-left output shaft; 313-chain; 314-first bearing; 315-second bearing; 4-guide assembly; 401-guide pulley; 5-energy storage device; 6-first BIPV panel; 7-second BIPV panel; 8-charging cable; 9-discharge cable; 10-parking and retrieval control panel; 11-wire rope; 12-hot-rolled angle steel; 13-mounting seat; 14-elastic washer; 15-fastener.

### DETAILED DESCRIPTION OF EMBODIMENTS

Principles and features of the disclosure are described below in conjunction with attached drawings. Embodiments provided are used solely to illustrate the disclosure and are not intended to limit the scope of the disclosure.

### Embodiment 1

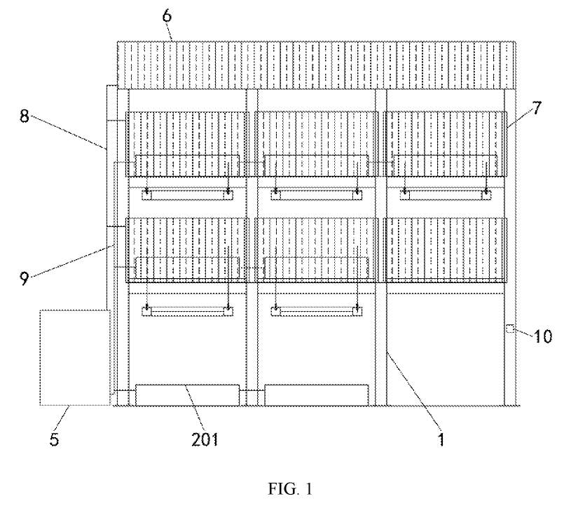

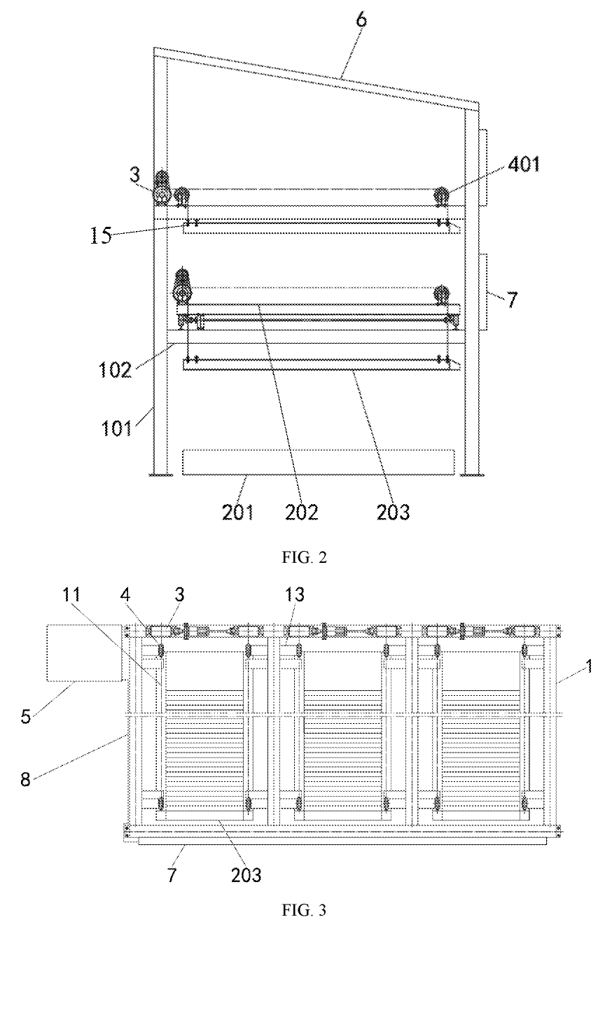

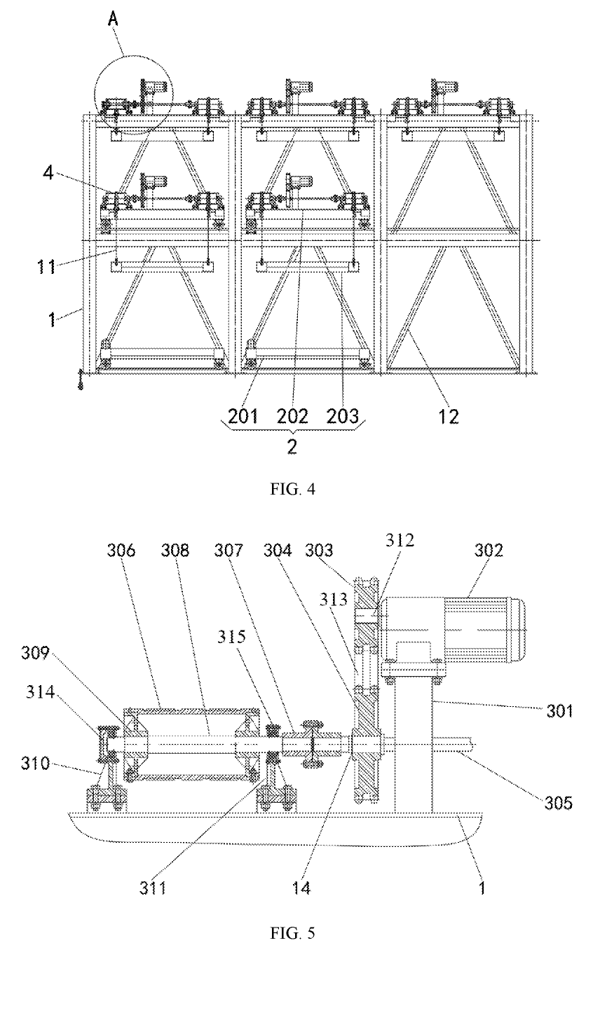

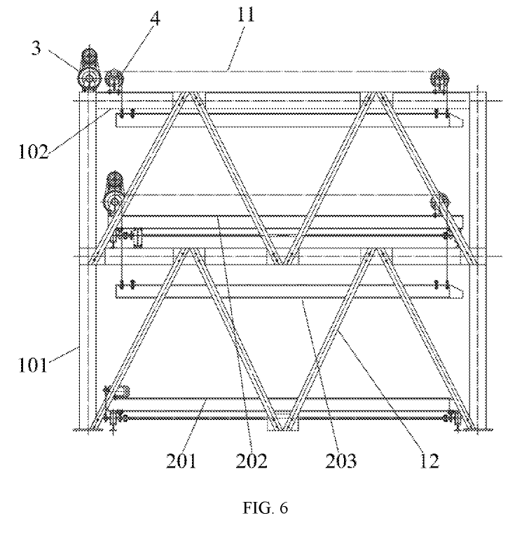

As shown in FIGS. 1-6, a BIPV parking garage with thermal insulation effects is provided, which includes a steel structure frame 1, a vehicle-carrying assembly 2, lifting assemblies 3, guide assemblies 4, and an energy storage device 5. The steel structure frame 1 is divided into three levels including an upper level, a middle level, and a lower level. A top of the steel structure frame 1 is fixedly connected to a bottom of a first BIPV panel 6, and a second BIPV panel 7 is fixedly mounted on a front side of the steel structure frame 1. The energy storage device 5 is disposed on a left side of the steel structure frame 1. Each of the first BIPV panel 6 and the second BIPV panel 7 is electrically connected to the energy storage device 5 via a charging cable 8. A discharge cable 9 is fixedly mounted on a top of the energy storage device 5. A parking and retrieval control panel 10 is fixedly mounted on the front side of the steel structure frame 1.

The vehicle-carrying assembly 2 includes lower horizontally-movable vehicle pallets 201, middle horizontally-movable vehicle pallets 202, and lifting vehicle pallets 203.

Each lifting assembly 3 includes a support base 301, a lifting motor 302, a first sprocket 303, a second sprocket 304, a drive shaft 305, and reels 306. A number of the reels 306 is two, and the two reels 306 are arranged in a left-right symmetrical configuration.

Each guide assembly 4 includes guide pulleys 401. The guide pulleys 401 of each guide assembly 4 at the upper level of the steel structure frame 1 are arranged in two groups each with two guide pulleys 401, and the two groups of the guide pulleys 401 are arranged in a left-right symmetrical configuration. Each group of the guide pulleys 401 is located on a front side of a corresponding one of the two reels 306 and shares a centerline with the reel 306.

Wire ropes 11 are wound around an outside of each reel 306, respectively pass through two guide pulleys 401 that are on a same side as the reel 306, and extend downward. A bottom of each wire rope 11 is fixed to a top of a corresponding one of the lifting vehicle pallets 202 via a fastener 15.

Each of the first BIPV panel 6 and the second BIPV panel 7 is electrically connected to the energy storage device via the charging cable 8 for storing electrical energy (converting solar energy into the electrical energy for storage is a conventional technique in the related art and will not be elaborated here). Furthermore, the combination of the first BIPV panel 6 and the second BIPV panel 7 blocks sunlight from the top and the front side of the parking garage, which reduces direct solar exposure to vehicles inside the outdoor parking garage and the consequent temperature increases inside the vehicles. The discharge cable 9 can supply power to each lifting assembly 3 and the parking and retrieval control panel 10. Each lifting vehicle pallet 203 is hoisted by four wire ropes 11, forming a rectangular configuration to ensure stability during lifting and lowering operations. This arrangement allows the vehicles to be parked on the upper, middle, and lower levels formed within the steel structure frame 1, thereby significantly improving space utilization efficiency of the entire outdoor parking garage. The parking and retrieval control panel 10 is configured to control an operation of each lifting assembly 3.

### Embodiment 2

This embodiment is a further improvement based on the embodiment 1, and is specifically configured as follows. The lifting motor 302 is fixedly mounted on a top of the support base 301. The first sprocket 302 is fixedly connected to an outside of a left output shaft 312 of the lifting motor 302, and the second sprocket 303 is located below the first sprocket 303. The first sprocket 303 and the second sprocket 304 are connected by a chain 313 to form a chain drive. The drive shaft 305 is fixedly connected to an inside of the second sprocket 304, and a right side of the drive shaft 305 penetrates through and extends to a right side of the support base 301. Two coupling 307 are fixedly mounted on a left side and the right side of the drive shaft 305, respectively. Two reel shafts 308 are fixedly mounted on opposite sides of the two couplings 307, respectively. The two reels 306 are respectively sleeved on outsides of the two reel shafts 308. Reel hubs 309 are fixedly mounted on an outside of each reel shafts 308, and are located on left and right sides of one of the two reels 306 that is on a same side as the reel shaft 308. First support frames 310 are respectively disposed on opposite sides of the two reel shafts 308, and second support frames 311 are respectively disposed on facing sides of the two reels 306. The opposite sides of the two reel shafts 308 are rotatably connected to facing sides of the first support frames 310 via first bearings 314. Respectively. Each of the two reel shafts 308 is rotatably mounted within a corresponding one of the second support frames 311 via a second bearing 315.

Upon startup, the lifting motor 302 drives the first sprocket 303 to rotate via the output shaft of the lifting motor 302. This rotation drives the second sprocket 304 through the chain drive, which in turn causes the drive shaft 305 to rotate. By means of the couplings 307 on the left and right sides of the drive shaft 305, the reel shafts 308 on the left and right sides of the drive shaft 305 are driven to rotate. Furthermore, with the cooperation of the first support frames 310 and the second support frames 311, the rotation of the reel shafts 308 is stabilized, thereby ensuring more stable rotation of the reels 306 during the winding of the wire ropes 11 and maintaining proper operation.

### Embodiment 3

This embodiment is a further improvement based on the embodiment 1, and is specifically configured as follows. The steel structure frame 1 is assembled from steel structure columns 101 and steel structure beams 102, and hot-rolled angle steels 12 are fixedly mounted on left, right, and rear sides of the steel structure frame 1.

Multiple steel structure columns 101 and steel structure beams 102 are assembled to form the outdoor parking garage with the three levels including the upper, middle, and lower levels, and the overall stability of the steel structure frame 1 is enhanced under actions of the hot-rolled steel angles 12.

### Embodiment 4

This embodiment is a further improvement based on the embodiment 3, and is specifically configured as follows. A number of the lifting assemblies 3 is five, and the five lifting assemblies 3 are arranged with three at the upper level and two at the middle level within the steel structure frame 1. Each of the support base 301, the first support frames 310, and the second support frames 311 of each lifting assembly 2 at the upper level of the steel structure frame 1 is fixedly mounted on a top of a corresponding one of the steel structure beams 102 at the upper level of the steel structure frame 1 via fasteners. Each of the support base 301, the first support frames 310, and the second support frames 311 of each lifting assembly 3 at the middle level of the steel structure frame 1 is fixedly connected to a top of a corresponding one of the middle horizontally-movable vehicle pallets 202.

The provision of multiple lifting assemblies 3 at different locations enhances the overall flexibility in vehicle lifting for the parking garage and also facilitates the selection of a suitable parking position based on actual conditions.

### Embodiment 5

This embodiment is a further improvement based on the embodiment 1, and is specifically configured as follows. A number of the guide assemblies 4 is five, and the five guide assemblies 4 are arranged with three at the upper level and two at the middle level within the steel structure frame 1. Each guide assembly 4 at the middle level of the steel structure frame 1 includes two guide pulleys 401 arranged in a left-right symmetrical configuration.

For each lifting assembly 3 at the middle level of the steel structure frame 1, the wire ropes 11 extend directly downward from the outsides of the reels 306, respectively. In coordination with the wire ropes 11 passing through the guide pulleys 401 on the front sides of the reels 306 respectively, a rectangular arrangement is similarly formed, thereby facilitating the subsequent lifting of a corresponding one of the lifting vehicle pallets 203.

### Embodiment 6

This embodiment is a further improvement based on the embodiment 3, and is specifically configured as follows. Mounting seats 13 are fixedly mounted on facing sides of adjacent two of the steel structure beams 102 at the upper level of the steel structure frame 1. The mounting seats 13 are arranged in two groups each with two mounting seats 13, and the two mounting seats 13 13 are arranged in a front-rear symmetrical configuration. The guide pulleys 401 of each guide assembly 4 at the upper level of the steel structure frame 1 are fixedly mounted on tops of the mounting seats 13, respectively. The guide pulleys 401 of each guide assembly 4 at the middle level of the steel structure frame 1 are fixedly mounted on a top of a corresponding one of the middle horizontally-movable vehicle pallets 202.

By mounting the guide pulleys 401 of each guiding assembly 4 at the upper level of the steel structure frame 1 on the mounting seats 13 respectively, it is ensured that each guide pulley 401 shares a common centerline with a reel 306 at a position corresponding to the guide pulley 401. This configuration maintains the stability of each guide pulley 401 during the lifting operation of the wire ropes 11. By mounting the guide pulleys 401 of each guide assembly 4 at the middle level of the steel structure frame 1 on the top of the corresponding middle horizontally-movable vehicle pallet 202, it is ensured that each guide pulley 401 shares a common centerline with a reel 306 at a position corresponding to the guide pulley 401.

### Embodiment 7

This embodiment is a further improvement based on the embodiment 4, and is specifically configured as follows. A number of the lower horizontally-movable vehicle pallets 201 is two, and a number of the middle horizontal-movable vehicle pallets 202 is two. The two lower horizontally-movable vehicle pallets 201 and the two middle horizontally-movable vehicle pallets 202 are respectively arranged on the lower level and the middle level within the steel structure frame 1. A number of the lifting vehicle pallets 203 is five, and the five lifting vehicle pallets 203 are respectively located below the five lifting assemblies 3.

The configuration that accommodates the use of multiple lifting assemblies 3 increases the overall spatial utilization rate within the steel structure frame 1.

### Embodiment 8

This embodiment is a further improvement based on the embodiment 2, and is specifically configured as follows. An elastic washer 14 is fixedly mounted on a left side of the second sprocket 304 and is located on an outside of the drive shaft 305.

The elastic washer 14, by virtue of its elasticity, can provide a cushioning effect and help maintain tightness in the connection between the second sprocket 304 and the drive shaft 305. Thereby, it helps prevent meshing issues between the chain and sprocket teeth caused by excessive slack or vibration during the transmission process, thereby ensuring the smooth operation of the chain drive system.

A working principle of the disclosure is as follows. First, the steel structure columns 101 are erected on front and rear sides. The steel structure beams 102 are then connected between the steel structure columns 101 to form the steel structure frame 1. The steel structure columns 101 on the rear side are higher than the steel structure columns 101 on the front side, facilitating the tilted installation of the first BIPV panel 6, thereby enhancing solar energy conversion efficiency of the first BIPV panel 6. In conjunction with the second BIPV panel 7 on the front side of the steel structure frame 1 and the hot-rolled steel angles 12 on the left, right, and rear sides of the steel structure frame 1, the overall stability of the steel structure frame 1 is improved. When parking is required, the lifting assemblies 3 at different positions are selectively operated based on actual conditions. The lifting motor 302 is activated, driving the first sprocket 303 to rotate via the output shaft of the lifting motor 302. This rotation drives the second sprocket 304 through the chain drive, which in turn rotates the drive shaft 30. By means of the couplings 307 on the left and right sides of the drive shaft 305, the reel shafts 308 on the left and right sides of the drive shaft 305 are driven to rotate. With the support of the first support frames 310 and the second support frames 311, the rotation of the reel shafts 308 is stabilized, ensuring more stable rotation of the reels 306 during the winding of the wire ropes 11 and maintaining proper operation. By winding the wire ropes 11, the corresponding lifting vehicle pallet 203 is raised or lowered, thereby carrying the vehicle on the lifting vehicle pallet 203 vertically to utilize spatial, or directly parking it at the lower level.

Although the embodiments of the disclosure have been shown and described above, it should be understood that the above embodiments are illustrative only and are not to be construed as limiting the disclosure. Within the scope of the disclosure, those skilled in the art may make changes, modifications, substitutions, and variations to the above embodiments.

What is claimed is:

1. A building integrated photovoltaics (BIPV) parking garage with thermal insulation effects, comprising: a steel structure frame (1), a vehicle-carrying assembly (2), lifting assemblies (3), guide assemblies (4), and an energy storage device (5), wherein the steel structure frame (1) is divided into three levels comprising an upper level, a middle level, and a lower level, a top of the steel structure frame (1) is fixedly connected to a bottom of a first BIPV panel (6), a second BIPV panel (7) is fixedly mounted on a front side of the steel structure frame (1), the energy storage device (5) is disposed on a left side of the steel structure frame (1), each of the first BIPV panel (6) and the second BIPV panel (7) is electrically connected to the energy storage device (5) via a charging cable (8), a discharge cable (9) is fixedly mounted on a top of the energy storage device (5), and a parking and retrieval control panel (10) is fixedly mounted on the front side of the steel structure frame (1);
wherein the vehicle-carrying assembly (2) comprises lower horizontal-movable vehicle pallets (201), middle horizontal-movable vehicle pallets (202), and lifting vehicle pallets (203);
wherein each of the lifting assemblies (3) comprises a support base (301), a lifting motor (302), a first sprocket (303), a second sprocket (304), a drive shaft (305), and reels (306), a number of the reels (306) is two, and the two reels (306) are arranged in a left-right symmetrical configuration;
wherein each of the guide assemblies (4) comprises guide pulleys (401), the guide pulleys (401) of each of the guide assemblies at the upper level of the steel structure frame (1) are arranged in two groups each with two of the guide pulleys (401), the two groups of the guide pulleys (401) are arranged in a left-right symmetrical configuration, and each group of the two groups of the guide pulleys (401) is located on a front side of a corresponding one of the two reels (306) and shares a centerline with the reel (306); and
wherein wire ropes (11) are wound around an outside of each of the two reels (306), respectively pass through two of the guide pulleys (401) that are on a same side as the reel (306), and extend downward; and a bottom of each of the wire ropes (11) is fixed to a top of a corresponding one of the lifting vehicle pallets (202) via a fastener (15).

2. The BIPV parking garage with thermal insulation effects as claimed in claim 1, wherein the lifting motor (302) is fixedly mounted on a top of the support base (301), the first sprocket (303) is fixedly connected to an outside of a left output shaft (312) of the lifting motor (302), the second sprocket (304) is located below the first sprocket (303), and the first sprocket (303) and the second sprocket (304) are connected by a chain (313) to form a chain drive; the drive shaft (305) is fixedly connected to an inside of the second sprocket (304), and a right side of the drive shaft (305) penetrates through and extends to a right side of the support base (301); two coupling (307) are fixedly mounted on a left side and the right side of the drive shaft (305) respectively, two reel shafts (308) are fixedly mounted on opposite sides of the two couplings (307) respectively, the two reels (306) are respectively sleeved on outsides of the two reel shafts (308), and reel hubs (309) are fixedly mounted on an outside of each of the two reel shafts (308), and are located on left and right sides of one of the two reels (306) that is on a same side as the reel shaft (308); first support frames (310) are respectively disposed on opposite sides of the two reel shafts (308), second support frames (311) are respectively disposed on facing sides of the two reels (306), the opposite sides of the two reel shafts (308) are rotatably connected to facing sides of the first support frames (310) via first bearings (314) respectively, and each of the two reel shafts (308) is rotatably mounted within a corresponding one of the second support frames (311) via a second bearing (315).

3. The BIPV parking garage with thermal insulation effects as claimed in claim 1, wherein the steel structure frame (1) is assembled from steel structure columns (101) and steel structure beams (102), and hot-rolled angle steels (12) are fixedly mounted on the left side, a right side, and a rear side of the steel structure frame (1).

4. The BIPV parking garage with thermal insulation effects as claimed in claim 3, wherein a number of the lifting assemblies (3) is five, and the five lifting assemblies (3) are arranged with three at the upper level and two at the middle level within the steel structure frame (1); and each of the support base (301), first support frames (310), and second support frames (311) of each of the lifting assemblies (2) at the upper level of the steel structure frame (1) is fixedly mounted on a top of a corresponding one of the steel structure beams (102) at the upper level of the steel structure frame (1), and each of the support base (301), the first support frames (310), and the second support frames (311) of each of the lifting assemblies (3) at the middle level of the steel structure frame (1) is fixedly connected to a top of a corresponding one of the middle horizontally-movable vehicle pallets (202).

5. The BIPV parking garage with thermal insulation effects as claimed in claim 1, wherein a number of the guide assemblies (4) is five, and the five guide assemblies (4) are arranged with three at the upper level and two at the middle level within the steel structure frame (1); and each of the guide assemblies (4) at the middle level of the steel structure frame (1) comprises two guide pulleys (401) arranged in a left-right symmetrical configuration.

6. The BIPV parking garage with thermal insulation effects as claimed in claim 3, wherein mounting seats (13) are fixedly mounted on facing sides of adjacent two of the steel structure beams (102) at the upper level of the steel structure frame (1), the mounting seats (13) are arranged in two groups each with two of the mounting seats (13), and the two of the mounting seats (13) are arranged in a front-rear symmetrical configuration; and the guide pulleys (401) of each of the guide assemblies (4) at the upper level of the steel structure frame (1) are fixedly mounted on tops of the mounting seats (13) respectively, and the guide pulleys (401) of each of the guide assemblies (4) at the middle level of the steel structure frame (1) are fixedly mounted on a top of a corresponding one of the middle horizontally-movable vehicle pallets (202).

7. The BIPV parking garage with thermal insulation effects as claimed in claim 4, wherein a number of the lower horizontally-movable vehicle pallets (201) is two, a number of the middle horizontal-movable vehicle pallets (202) is two, and the two lower horizontally-movable vehicle pallets (201) and the two middle horizontally-movable vehicle pallets (202) are respectively arranged on the lower level and the middle level within the steel structure frame (1); and a number of the lifting vehicle pallets (203) is five, and the five lifting vehicle pallets (203) are respectively located below the five lifting assemblies (3).

8. The BIPV parking garage with thermal insulation effects as claimed in claim 2, wherein an elastic washer (14) is fixedly mounted on a left side of the second sprocket (304) and is located on an outside of the drive shaft (305).

9. The BIPV parking garage with thermal insulation effects as claimed in claim 1, wherein the discharge cable (9) is configured to supply power to the lifting assemblies (3) and the parking and retrieval control panel (10).

10. A BIPV parking garage with thermal insulation effects, comprising:
a steel structure frame (1), divided into an upper level, a middle level, and a lower level;
a vehicle-carrying assembly (2), comprising:
lower horizontal-movable vehicle pallets (201), disposed on the lower level of the steel structure frame (1);
middle horizontal-movable vehicle pallets (202), disposed on the middle level of the steel structure frame (1); and
lifting vehicle pallets (203), vertically movably disposed in the steel structure frame (1);
lifting assemblies (3), each comprising: a lifting motor (302), reels (306), and wire ropes (11), wherein the lifting motor (302) is in transmission connection with the reels (306), and an end of each of the wire ropes (11) is wound around an outside of a corresponding one of the reels (306);
guide assemblies (4), each comprising: guide pulleys (401), wherein another end of each of the wire ropes (11) passes through a corresponding one of the guide pulleys (401) and is fixedly connected to a corresponding one of the lifting vehicle pallets (203);
a first BIPV panel (6), fixedly connected to a top of the steel structure frame (1);
a second BIPV panel (7), fixedly mounted on a front side of the steel structure frame (1);
an energy storage device (5), disposed on a left side of the steel structure frame (1), wherein each of the first BIPV panel (6) and the second BIPV panel (7) is electrically connected to the energy storage device (5); and
a parking and retrieval control panel (10), fixedly mounted on the front side of the steel structure frame (1).

11. The BIPV parking garage with thermal insulation effects as claimed in claim 10, further comprising a discharge cable (9), wherein the discharge cable (9) is fixedly mounted on a top of the energy storage device (5) and configured to supply power to the lifting assemblies (3) and the parking and retrieval control panel (10).

12. The BIPV parking garage with thermal insulation effects as claimed in claim 10, wherein a number of the guide assemblies (3) is five, and the five guide assemblies (4) are arranged with three at the upper level and two at the middle level within the steel structure frame (1); each of the guide assemblies (3) at the upper level of the steel structure frame (1) comprises four guide pulleys (401) arranged in two groups each with two of the four guide pulleys (401), and the two groups of the four guide pulleys (401) are arranged in a left-right symmetrical configuration; and each of the guide pulleys (401) at the middle level of the steel structure frame (1) comprises two guide pulleys (401) arranged in a left-right symmetrical configuration.

13. The BIPV parking garage with thermal insulation effects as claimed in claim 10, wherein a number of the reels (306) is two, and the two reels (306) are arranged in a left-right symmetrical configuration; each of the lifting assemblies (3) further comprises a support base (301), a first sprocket (303), a second sprocket (304), and a drive shaft (305), the lifting motor (302) is fixedly mounted on a top of the support base (301), the first sprocket (303) is fixedly connected to an outside of a left output shaft (312) of the lifting motor (302), the second sprocket (304) is located below the first sprocket (303), and the first sprocket (303) and the second sprocket (304) are connected by a chain (313) to form a chain drive; the drive shaft (305) is fixedly connected to an inside of the second sprocket (304), and a right side of the drive shaft (305) penetrates through and extends to a right side of the support base (301); two coupling (307) are fixedly mounted on a left side and the right side of the drive shaft (305) respectively, two reel shafts (308) are fixedly mounted on opposite sides of the two couplings (307) respectively, the two reels (306) are respectively sleeved on outsides of the two reel shafts (308), and reel hubs (309) are fixedly mounted on an outside of each of the two reel shafts (308), and are located on left and right sides of one of the two reels (306) that is on a same side as the reel shaft (308); first support frames (310) are respectively disposed on opposite sides of the two reel shafts (308), second support frames (311) are respectively disposed on facing sides of the two reels (306), the opposite sides of the two reel shafts (308) are rotatably connected to facing sides of the first support frames (310) respectively, and each of the two reel shafts (308) is rotatably mounted within a corresponding one of the second support frames (311).

14. The BIPV parking garage with thermal insulation effects as claimed in claim 12, wherein the steel structure frame (1) is assembled from steel structure columns (101) and steel structure beams (102), and hot-rolled angle steels (12) are fixedly mounted on the left side, a right side, and a rear side of the steel structure frame (1).

15. The BIPV parking garage with thermal insulation effects as claimed in claim 13, wherein an elastic washer (14) is fixedly mounted on a left side of the second sprocket (304) and is located on an outside of the drive shaft (305).

16. The BIPV parking garage with thermal insulation effects as claimed in claim 14, wherein mounting seats (13) are fixedly mounted on facing sides of adjacent two of the steel structure beams (102) at the upper level of the steel structure frame (1), the mounting seats (13) are arranged in two groups each with two of the mounting seats (13), and the two of the mounting seats (13) are arranged in a front-rear symmetrical configuration; the four guide pulleys (401) of each of the guide assemblies (4) at the upper level of the steel structure frame (1) are fixedly mounted on tops of the mounting seats (13) respectively, and the two guide pulleys (401) of each of the guide assemblies (4) at the middle level of the steel structure frame (1) are fixedly mounted on a top of a corresponding one of the middle horizontally-movable vehicle pallets (202).

17. The BIPV parking garage with thermal insulation effects as claimed in claim 14, wherein a number of the lifting assemblies (3) is five, and the five lifting assemblies (3) are arranged with three at the upper level and two at the middle level within the steel structure frame (1); and each of a support base (301), first support frames (310), and second support frames (311) of each of the lifting assemblies (2) at the upper level of the steel structure frame (1) is fixedly mounted on a top of a corresponding one of the steel structure beams (102) at the upper level of the steel structure frame (1), and each of the support base (301), the first support frames (310), and the second support frames (311) of each of the lifting assemblies (2) at the middle level of the steel structure frame (1) is fixedly connected to a top of a corresponding one of the middle horizontally-movable vehicle pallets (202).

18. The BIPV parking garage with thermal insulation effects as claimed in claim 17, wherein a number of the lower horizontally-movable vehicle pallets (201) is two, a number of the middle horizontal-movable vehicle pallets (202) is two, a number of the lifting vehicle pallets (203) is five, and the five lifting vehicle pallets (203) are respectively located below the five lifting assemblies (3).

19. A BIPV parking garage with thermal insulation effects, comprising:
a steel structure frame (1), divided into an upper level, a middle level, and a lower level, wherein the steel structure frame (1) is assembled from steel structure columns (101) and steel structure beams (102), and hot-rolled angle steels (12) are fixedly mounted on the left side, a right side, and a rear side of the steel structure frame (1);
lifting assemblies (3), each comprising: a lifting motor (302), reels (306), and wire ropes (11), wherein the lifting motor (302) is in transmission connection with the reels (306), and an end of each of the wire ropes (11) is wound around an outside of a corresponding one of the reels (306);
guide assemblies (4), each comprising: guide pulleys (401), wherein another end of each of the wire ropes (11) passes through a corresponding one of the guide pulleys (401);
a vehicle-carrying assembly (2), comprising:
lower horizontal-movable vehicle pallets (201), disposed on the lower level of the steel structure frame (1);
middle horizontal-movable vehicle pallets (202), disposed on the middle level of the steel structure frame (1); and
lifting vehicle pallets (203), respectively located below the lifting assemblies (3) and vertically movably disposed in the steel structure frame (1), wherein the another end of each of the wire ropes (11) is further fixedly connected to a corresponding one of the lifting vehicle pallets (203);
a first BIPV panel (6), fixedly connected to a top of the steel structure frame (1);
a second BIPV panel (7), fixedly mounted on a front side of the steel structure frame (1);
an energy storage device (5), disposed on a left side of the steel structure frame (1), wherein each of the first BIPV panel (6) and the second BIPV panel (7) is electrically connected to the energy storage device (5);
a parking and retrieval control panel (10), fixedly mounted on the front side of the steel structure frame (1); and
a discharge cable (9), fixedly mounted on a top of the energy storage device (5) and configured to supply power to the lifting assemblies (3) and the parking and retrieval control panel (10).

20. The BIPV parking garage with thermal insulation effects as claimed in claim 19, wherein a number of the reels (306) is two, and the two reels (306) are arranged in a left-right symmetrical configuration; each of the lifting assemblies (3) further comprises a support base (301), a first sprocket (303), a second sprocket (304), and a drive shaft (305), the lifting motor (302) is fixedly mounted on a top of the support base (301), the first sprocket (303) is fixedly connected to an outside of a left output shaft (312) of the lifting motor (302), the second sprocket (304) is located below the first sprocket (303), and the first sprocket (303) and the second sprocket (304) are connected by a chain (313) to form a chain drive; the drive shaft (305) is fixedly connected to an inside of the second sprocket (304), and a right side of the drive shaft (305) penetrates through and extends to a right side of the support base (301); two coupling (307) are fixedly mounted on a left side and the right side of the drive shaft (305) respectively, two reel shafts (308) are fixedly mounted on opposite sides of the two couplings (307) respectively, the two reels (306) are respectively sleeved on outsides of the two reel shafts (308), and reel hubs (309) are fixedly mounted on an outside of each of the two
reel shafts (308), and are located on left and right sides of one of the two reels (306) that is on a same side as the reel shaft (308); first support frames (310) are respectively disposed on opposite sides of the two reel shafts (308), second support frames (311) are respectively disposed on facing sides of the two reels (306), the opposite sides of the two reel shafts (308) are rotatably connected to facing sides of the first support frames (310) respectively, and each of the two reel shafts (308) is rotatably mounted within a corresponding one of the second support frames (311).
